(19) United States
(12) Patent Application Publication
(10) Pub. No.: US 2012/0109743 A1
(43) Pub. Date: May 3, 2012

(54) METHOD AND SYSTEM FOR SCHEDULING AN ADVERTISEMENT

(75) Inventors: Ajit Balakrishnan, Maharashtra (IN); Pravin Yeluri, Maharashtra (IN)

(73) Assignee: Vubites India Private Limited, Mumbai (IN)

(21) Appl. No.: 13/266,971

(22) PCT Filed: Apr. 28, 2010
(86) PCT No.: PCT/IN2010/000270

§ 371 Date: Jan. 13, 2012

(30) Foreign Application Priority Data
Apr. 28, 2009 (IN) 1122/MUM/2009

(51) Int. Cl. G06Q 30/02

(52) U.S. Cl. 705/14.44; 705/14.4

(57) ABSTRACT

A method and system for broadcasting multimedia data is disclosed. In an embodiment, a method for broadcasting multimedia data is disclosed. The method comprising generating one or more multimedia data streams using the multimedia data, scheduling the one or more multimedia data streams at one or more timing slots of one or more advertisement, and processing the one or more multimedia data streams with a first data stream at the one or more timing slots. The method further comprises inserting multimedia data streams within the first data stream in accordance with a geographic location.

### CROSS-REFERENCE TO RELATED APPLICATIONS

This application claims benefit of Indian provisional patent application serial number 1122/MUM/2009, filed on Apr. 28, 2009, which is herein incorporated by reference

### FIELD OF THE INVENTION

Embodiments of the present invention generally relate to processing multimedia data, and more particularly to a method and system for creating, planning and communicating the multimedia advertisement.

### DESCRIPTION OF THE RELATED ART

Broadcasting (e.g. television, radio and the like) among others, is one of the most important means of mass communication. Communication on such means is among the most prevalent and effective means of advertising. In today's competitive business environment, users such as, service or product providers, small to medium sized organizations, freelancing groups, individuals and/or the like seek to reach out new and/or potential customers.

Various advertising agencies are involved in generating the advertisements for the users. The advertisements are communicated to the various advertisement channels, such as television broadcasting channels, radio broadcasting channels, internet channels, and the like. As such, each advertisement channel at different time intervals has different target audiences that may include the user customers. The advertisement channels charge the users different rates for a particular multimedia advertisement at the different time intervals. In several cases, the advertising agencies generate the advertisements and advise the users on appropriate scheduling of their advertisements. Subsequently, the multimedia advertisements are inserted in the data stream broadcasted by the advertisement channels.

In most cases, engaging advertising agencies for creation and/or scheduling of multimedia advertisements is cost prohibitive for many businesses or potential users of the broadcast advertising. Typically, companies need to invest a lot of money to run an advertisement campaign on the broadcast channel to reach their target groups. Even after spending large sums of money, an advertiser (or user) ends up paying for showing the advertisement to several people or groups of people who are not a target audience for the user. This occurs because the same broadcast stream received from a broadcasting device (e.g. satellite, transmitter and the like) is transmitted by all local stations (e.g. head ends) to plurality of devices (e.g., television, computer and the like). Further, the users are generally unaware of the different target audiences associated with the advertisement channels or the viewership timings suited to their product being advertised.

Furthermore, broadcasting enables a singe broadcasting channel to cover a large geographical region (e.g., a country, a state) and much of broadcasted advertisements on such channel may be irrelevant to several people within that region. For example, while advertisement of a city car may be of interest to viewers in the city, viewers of a neighboring and/or distant village (where farming may be the prime occupation) may find an advertisement on car irrelevant. Village viewers who are farmers may be more interested in farming equipment and/or vehicles such as a tractor, which, for example, may be irrelevant for most city viewers. Moreover, broadcasting same multimedia advertisement over the different geographical regions may limit the revenues of the broadcasting channels. For example, broadcasting channels are not able to attract a large number of low budget advertisers or users of the respective geographical regions.

Therefore, there is a need in the art to provide methods and systems that allow users or advertisers to show their advertisements in a targeted manner, such as in specific geographical locations, for example, and further to show these advertisements in a cost effective manner.

### SUMMARY OF THE INVENTION

A method and system for broadcasting multimedia data is disclosed. In an embodiment, a method for broadcasting multimedia data is disclosed. The method comprising generating one or more multimedia data streams using the multimedia data, scheduling the one or more multimedia data streams at one or more timing slots of one or more advertisement, and processing the one or more multimedia data streams with a first data stream at the one or more timing slots.

In another embodiment, a method for broadcasting multimedia data is disclosed. The method comprising providing the multimedia data, generating one or more multimedia data streams using the multimedia data, scheduling of the one or more multimedia data streams at one or more timing slots of advertisement channels, processing the multimedia data streams with a first data stream at the one or more timing slots, and rendering an output stream on a plurality of devices for accessing to users.

In a yet another embodiment, a system for broadcasting multimedia data comprising a stream generator for generating a multimedia data stream from the multimedia data, a media planner for providing a list of one or more timing slots in advertisement channels, and a plurality of processing stations for generating an output stream by processing the multimedia data streams with a first data stream at the one or more timing slots.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a block diagram of an example system for broadcasting multimedia data in accordance with one or more embodiments of the invention;

FIG. 2 illustrates an example flow diagram in accordance with one or more embodiments of the invention; and

FIG. 3 illustrates an example flow diagram in accordance with one or more embodiments of the invention.

### DETAILED DESCRIPTION

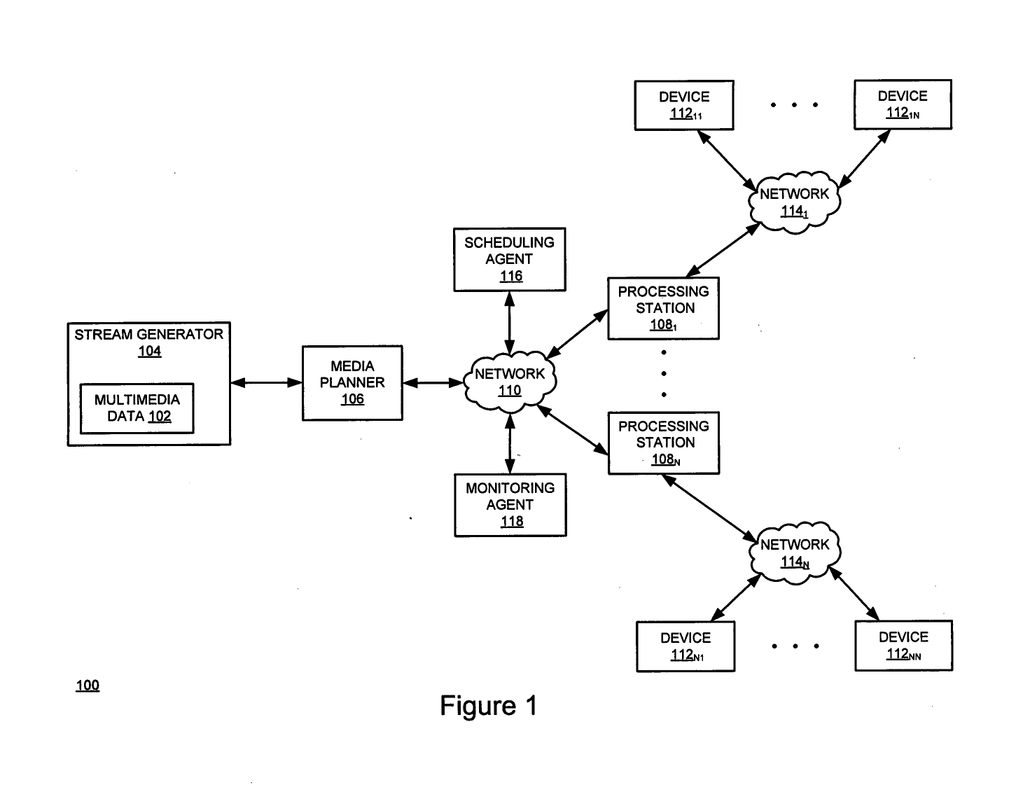

FIG. 1 illustrates a block diagram of an example system 100 for broadcasting multimedia data in accordance with one or more embodiments of the invention. The system 100 includes a stream generator 104, a media planner 106, coupled to a plurality of processing stations 108 (illustrated as a processing station 108₁ . . . , and a processing station 108ₙ) through a network 110.

The stream generator 104 includes a plurality of software packages for generating a multimedia data stream from multimedia data 102. The multimedia data 102 includes data in one or more multimedia advertisement files, a plurality of library files and/or like. The library files can include various image files, video files, audio files, text files and/or the like. The image files include files having image file format such as, .GIF, .JPEG, .BMP and/or other image file formats generally known in the art. Additionally, the audio files include files having audio file format, such as, .WAV, .AU, .MP3, and/or other audio file formats generally known in the art. Furthermore, the video files include files having video file format such as, .MP4, .MPEG, .WMV and/or other video file formats generally known in the art.

According to one or more embodiments of the invention, the multimedia data stream is in accordance with various compression technologies, such as, JPEG, MPEG (e.g., MPEG-1, MPEG-2, and MPEG-4), H.26X and/or the like. The stream generator 104 provides users an access to the plurality of software packages for generating the multimedia data stream. Generally, the multimedia data stream includes one or more multimedia advertisements that may depict information regarding products and/or services being offered by the users. Further, the stream generator 104 may generate a multimedia data stream that includes multilingual advertisements for the users such as advertisers. Additionally, the users may edit partly and/or wholly the multimedia data stream in accordance with the products and/or services.

The media planner 106 includes a plurality of software packages that provides a list of one or more timing slots in various advertisement channels such as, broadcasting channels, such as, television channels, radio channels, video on demand service channels, online video streaming channels, internet television channels, and/or other electronic multimedia channels generally known in the art. Generally, the media planner 106 utilizes campaign information (e.g., target audience, business category, industry specification, demographic location, advertisement channels preference, campaign timing data, financial budget and/or the like) and market survey information (e.g., advertisement channels ratings, various market reviews and/or analysis data of the one or more timing slots and/or the like) for providing a list. Accordingly, the users select the one or more timing slots of the advertisement channels for the multimedia data stream. Subsequently, the system 100 transmits the multimedia data streams to the plurality of processing stations 108 through the network 110.

The network 110 comprises a communication system that connects computers by wire, cable, fiber optic and/or wireless link facilitated by various types of well-known network elements, such as hubs, switches, routers, and the like. The network 110 may employ various well-known protocols to communicate information amongst the network resources. For example, the network 110 may be a part of the internet or intranet using various communications infrastructure such as Ethernet, WiFi, WiMax, General Packet Radio Service (GPRS), and the like. Furthermore, the network 110 may form a portion of a Storage Network Area (SAN) using various, communications infrastructure such as Ethernet, Fibre Channel, InfiniBand, iSCSI and the like.

According to one or more embodiments of the invention, the processing stations 108 are servers (e.g., web servers) that provide online services to the users. Generally, the servers includes multimedia content in various forms such as, web pages, online video streaming channels, internet television channels and the like. Subsequently, the server modifies the multimedia content at the one or more timing slots in accordance with contents of the one or more multimedia data stream.

According to one or more embodiments of the invention, the processing stations 108 are broadcasting stations (e.g., media broadcasting station, Internet broadcasting station, television broadcasting station, radio broadcasting station, and the like). Generally, the broadcasting station generates a first data stream. As such, the first data stream is a multimedia program stream that includes data of one or more programs. Subsequently, the broadcasting stations insert the multimedia data stream within the first data stream at the one or more timing slots.

According to one or more embodiments of the invention, the plurality of processing stations 108 are cable head ends in a digital transmission system. Generally, the cable head ends receive the first data stream from one or more source stations (e.g., television broadcasting stations). In one embodiment, the first data stream is a compressed data stream and is generated using various compression technologies, such as, JPEG, MPEG (e.g., MPEG-1, MPEG-2, and MPEG-4), H.26X and/or the like. In other embodiments, the cable head ends processes the first data stream in accordance with the various compression technologies.

Additionally, the cable head ends include one or more splicers for performing various operations on the first data stream. In one embodiment, the cable head ends perform splicing operations on the first data stream and multimedia data stream at the one or more user selected timing slots using a combination of hardware and software modules. In an optional embodiment, the cable head end may access a storage that provides one or more multimedia streams for splicing the first data stream with the one or more multimedia streams. For example, the cable head end may access an advertisement server for performing the splicing operation.

Further, the first data stream includes one or more streams (e.g., video stream, audio stream and the like) and accordingly, the cable head ends achieve timing synchronization within the one or more streams of the first data stream. In one embodiment, the cable head ends achieve timing synchronization using software modules.

Accordingly, each processing station 108 generates an output stream that includes processed first data stream and the multimedia data stream. Further, each processing station 108 is coupled to a plurality of devices through a network 114 (illustrated as a network 114₁ . . . , and a network 114). For example, the processing station 108₁ is coupled to a plurality of devices (illustrated as a device 112₁₁ . . . , and a device 112₁ₙ) through the network 114₁. Accordingly, the processing stations 108 transmit the output stream to the plurality of devices 112 through the network 114.

The network 114 comprises a communication system that connects computers by wire, cable, fiber optic and/or wireless link facilitated by various types of well-known network elements, such as hubs, switches, routers, and the like. The network 114 may employ various well-known protocols to communicate information amongst the network resources. For example, the network 114 may be a part of the internet or intranet using various transmission systems such as Broadcast transmission systems, which employs various modulation techniques, various interfaces (e.g., Asynchronous Serial Interface (ASI)), transmission means (e.g., RF cables, Optical fibers, Satellite Links) and/or the like. Alternatively, the network 114 may be a part of an Internet protocol network on Ethernet, Wi-Fi or fiber or dedicated lines, ATM networks etc.

The device 112 may be a desktop computer, a laptop, a mobile phone, a Personal Digital Assistant (PDA), a digital television, a set-top box and/or the like. Consequently, the user accesses the output stream through the device 112.

According to one or more embodiments of the invention, the system 100 includes a scheduling agent 116 that communicates the multimedia data streams from the plurality of media planners 106 to the plurality of processing stations 108. The system 100 further includes a monitoring agent 118 that monitors the content of the multimedia data stream. For example, the monitoring agent 118 monitors the quality of the multimedia advertisements within the multimedia data stream. Further, the monitoring agent 118 may determine the contents of the multimedia data stream. For example, the monitoring agent 118 determines one or more multimedia advertisements that may not be included within the multimedia data stream.

According to one or more embodiments, the system 100 utilizes the scheduling agent 116 for generating a schedule of the plurality of processing stations 108 in accordance with a media plan generated by the media planner 106. For example, the scheduling agent 116 generates a twenty four hour scheduling plan for the splicers of the processing stations 108 located across different geographic locations. Further, the scheduling agent 116 may modify the schedule to compensate any timing mismatch.

Consequently, the system 100 advertises the multimedia advertisement in various media channels, video on demand service channels, online video streaming channels, internet television channels, print channels (e.g., newspapers, magazines, and other publications), theaters, cinematography and the like.

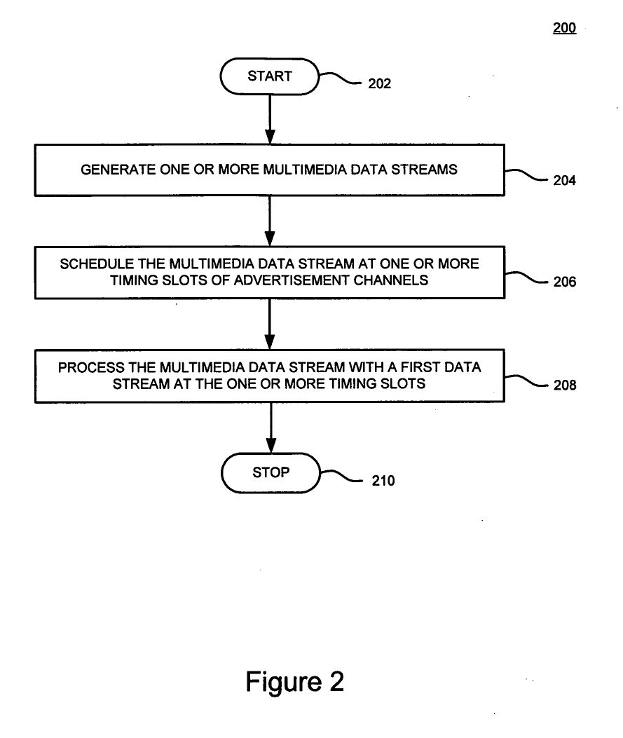

FIG. 2 illustrates an example flow diagram 200 in accordance with one or more embodiments of the invention. The method 200 starts at step 202 and proceeds to step 204. At step 204, one or more multimedia data streams are generated from the multimedia data. In an embodiment, a stream generator (e.g., the stream generator 104 of the FIG. 1) generates the one or more multimedia data streams.

At step 206, the multimedia data stream at one or more timing slots of the advertisement channels is scheduled. At step 208, the multimedia data streams are processed with a first data stream at the one or more timing slots of the advertisement channels. The method 200 proceeds to step 210. At the step 210, the method 200 ends.

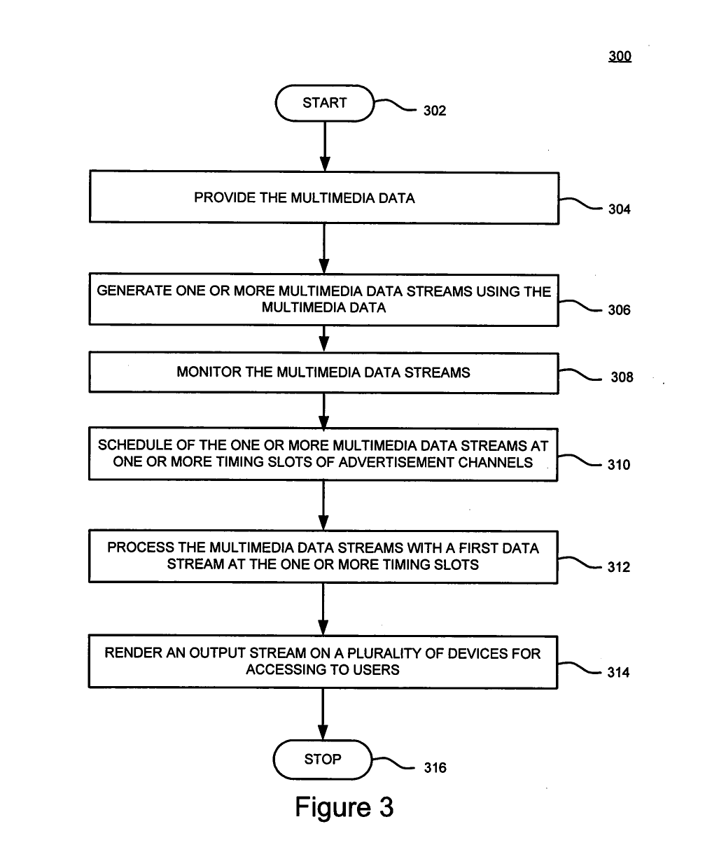

FIG. 3 illustrates an example flow diagram 300 in accordance with one or more embodiments of the invention. The method 300 starts at step 302 and proceeds to step 304. At step 304, multimedia data is provided. At step 306, one or more multimedia data streams are generated from the multimedia data. In an embodiment, a stream generator (e.g., the stream generator 104 of the FIG. 1) generates the one or more multimedia data streams. At step 308, the multimedia data streams are monitored. In an embodiment, the contents of the multimedia data stream are monitored by the monitoring agent 118. For example, the monitoring agent 118 monitors quality, format, and content correctness of the multimedia data streams.

At step 310, the multimedia data stream is scheduled at one or more timing slots of the advertisement channels. At step 312, the multimedia data streams are processed with a first data stream at the one or more timing slots of the advertisement channels. At step 314, an output stream is rendered on a plurality of devices for accessing to users. The method 300 proceeds to step 316. At the step 316, the method 300 ends.

The present techniques present an innovative manner of broadcast advertising by allowing broadcasters to show advertisements in comparatively smaller viewer groups within a geographical location. This allows for more focused advertising, and offers small budget advertisers affordability to advertise in their regions of interest. Further, the techniques discussed herein enable a new mode of conducting advertising business such that broadcasters may engage with a higher number of advertisers (including small budget advertisers), while making advertising affordable by targeting smaller communities. Further, the techniques discussed according to various embodiments allow for an advertising business model that allows greater flexibility to advertisers to pay for showing the advertisements to the communities of interest, and broadcasters to seek a higher number of advertisers and potentially increase revenues. Furthermore, the techniques discussed according to various embodiments allow advertisers to reach particular lingual groups of customers spread across different geographies using multilingual advertisements. For example, aforementioned techniques allow the broadcasters to show simultaneously various multilingual advertisements for an advertiser across the different geographies. Another benefit is that the viewers are shown advertisements by local businesses and the like, which may be generally more useful for the viewers.

While the foregoing is directed to embodiments of the invention, other and further embodiments of the invention may be devised without departing from the basic scope thereof.

1. A method for broadcasting a multimedia data comprising:
generating one or more multimedia data streams from the multimedia data;
scheduling of the one or more multimedia data streams at one or more timing slots of advertisement channels; and
processing the multimedia data streams with a first data stream at the one or more timing slots.

2. The method of claim 1 further comprising monitoring the content of the multimedia data stream.

3. The method of claim 1, wherein scheduling comprises providing a list for the one or more timing slots in the advertisement channels.

4. The method of claim 1 further comprising rendering an output stream on a plurality of devices for accessing to users.

5. A method for broadcasting multimedia data comprising:
providing the multimedia data;
generating one or more multimedia data streams using the multimedia data;
monitoring the multimedia data streams;
scheduling of the one or more multimedia data streams at one or more timing slots of advertisement channels;
processing the multimedia data streams with a first data stream at the one or more timing slots; and
rendering an output stream on a plurality of devices for accessing to users.

6. A system for broadcasting multimedia data comprising:
a stream generator for generating a multimedia data stream from the multimedia data;
a media planner operatively coupled to the stream generator for providing a list of one or more timing slots in advertisement channels; and
a plurality of processing stations operatively coupled to the media planner for generating an output stream by processing the multimedia data streams with a first data stream at the one or more timing slots.

7. The system of claim 6, wherein the multimedia data stream utilizes compression techniques selected from a group comprising JPEG (Joint Photographic Experts Group), Moving Picture Experts Group (MPEG) (e.g., MPEG-1, MPEG-2, and MPEG-4), and H.26X.

8. The system of claim 6, wherein the multimedia data is selected from a group comprising multimedia advertisement files, image files, video files, audio files, and text files.

9. The system of claim 6, wherein the multimedia data stream comprises one or more multimedia advertisements, the multimedia advertisements depict information regarding products and/or services being offered by users.

10. The system of claim 6 further comprising a scheduling agent for generating a schedule of the plurality of processing stations in accordance with a media plan generated by the media planner.

11. The system of claim 6 further comprising a monitoring agent for monitoring the content of the multimedia data stream.

12. The system of claim 6, wherein the advertisement channels are selected from a group comprising broadcasting channels, television channels, radio channels, video on demand service channels, online video streaming channels, internet television channels, and/or other electronic multimedia channels.

13. The system of claim 6, wherein the media planner utilizes campaign information and market survey information for providing the list for one or more timing slots in the advertisement channels.

14. The system of claim 13, wherein the campaign information is selected from a group comprising a target audience, a business category, an industry specification, a demographic location, advertisement channels preference, a campaign timing data, and a financial budget.

15. The system of claim 13, wherein the market survey information is selected from a group comprising advertisement channels ratings, various market reviews and/or analysis data of the one or more timing slots.

16. The system of claim 6 further comprising a plurality of devices for receiving the output stream for accessing to users.
